(19) United States
(12) Patent Application Publication
(10) Pub. No.: US 2014/0077959 A1
(43) Pub. Date: Mar. 20, 2014

(54) A/C GHOST GUARD

(71) Applicants: MARCIAL A. BELLOTA, Miami, FL (US); Melanie Bellota, Miami, FL (US)

(72) Inventors: MARCIAL A. BELLOTA, Miami, FL (US); Melanie Bellota, Miami, FL (US)

(21) Appl. No.: 13/616,470

(22) Filed: Sep. 14, 2012

(51) Int. Cl. G08B 21/00

(52) U.S. Cl. 340/626

(57) ABSTRACT

A high pressure switch works to protect the air conditioner (a/c) compressor from operational conditions, and now we also can protect the whole a/c condenser unit (outdoor unit) from theft and vandalism. The safeguard can be accomplished by installing another high pressure switch on the high pressure liquid line or close to the a/c indoor air handler as shown and wired to the central box of the alarm system.

### CROSS-REFERENCE TO RELATED APPLICATIONS

This application is related to the provisional application No. 61/628,653 filed on Nov. 1, 2011 by Marcial A. Bellota and Melanie Bellota for the A/C ghost guard.

### STATEMENTS REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention is based on a new application of an existing part. Normally this type of pressure switch is installed on the air conditioner systems to protect the compressor in case the gas pressure drops due to a leak. We are suggesting that the device be instead installed in the high pressure line and connected to the home burglary alarm system to prevent the theft of the outdoor units. In recent events, the rise in the price of the copper has prompted an increase to the number of air conditioning units stolen from both commercial and residential properties. The air conditioning units are stolen and then sold for parts as scrap metal.

### BRIEF SUMMARY OF THE INVENTION

Air conditioning system manufacturers install a high pressure switch in each compressor. The compressor is the principal component of an air conditioning system. In order to prevent malfunctions, the manufacturers install safety switches. The switch is installed in the liquid line of the compressor, the exit line.

We have seen in the news increased theft of air conditioning units due to increasing prices of copper as a scrap metal. The cooling coil within air conditioning units are made of copper and are subject to these thefts. The units lack any protection mechanism against theft or vandalism. In recent news, we have also seen persons inhaling Freon gas as a new alternative to getting high off its chemical properties and this new practice in many cases leads to death.

These issues can be addressed using the same switch in place to protect units. A high pressure switch works to protect the air conditioner (a/c) compressor from operational conditions, and now we also can protect the whole a/c condenser unit (outdoor unit) from theft and vandalism. The safeguard can be accomplished by installing another high pressure switch on the high pressure liquid line or close to the a/c indoor air handler t as shown (FIG. 1-3) and wired to the central box of the alarm system (FIG. 1-7). The pressure switch should not be installed to the gas line or the low pressure line as each time units start the pressure in the tube decreases to between 50 to 60 psi, and would activate the alarm unnecessarily.

### BRIEF DESCRIPTION OF THE SEVERAL VIEWS OF THE DRAWING

FIG. 1 depicts the location of the switch on the interior of the building and connected to the burglar alarm system.
1. Air Conditioner Condenser Unit (Exterior Unit)
2. Wall of the Building
3. Proposed Location Where Device Must Be Install (A/C Ghost Guard)
4. High Pressure Line Or Liquid Line (Copper Tube)
5. Low Pressure Line Or Gas Line (Copper Tube)
6. A/C Air Handler (Interior Unit)
7. Wires To The Alarm System (New or Existing)
8. Alarm System Box

FIG. 2 depicts the detailed installation of the wiring, switch and the copper line.
1. Wires To The Alarm System Box.
2. Contacts (Inside The Pressure Switch).
3. Actuator (Will Keep Contacts Close While Gas Pressure Push It Up)
4. Gas Pressure.
5. High Pressure Line To The Condenser Unit (Previously Cut).
6. High Pressure Line To The Air Handler Unit.
7. Access Valve (Must Be Weld To Both Ends Of The High Pressure Lines).
8. Pressure Switch (Is Screwed To The Access Valve).

FIG. 3 depicts the location of the pressure switch in an air conditioning system unit.

### DETAILED DESCRIPTION OF THE INVENTION

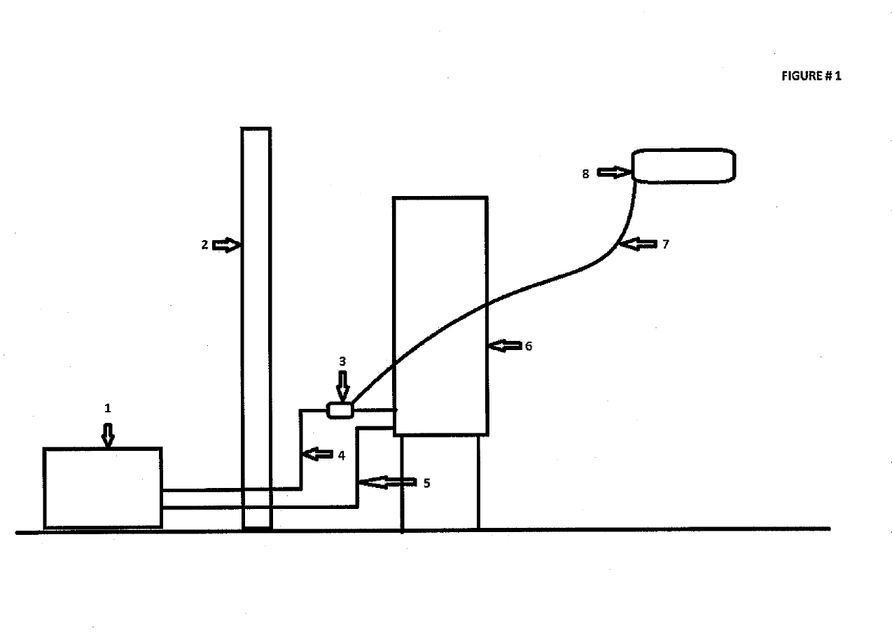

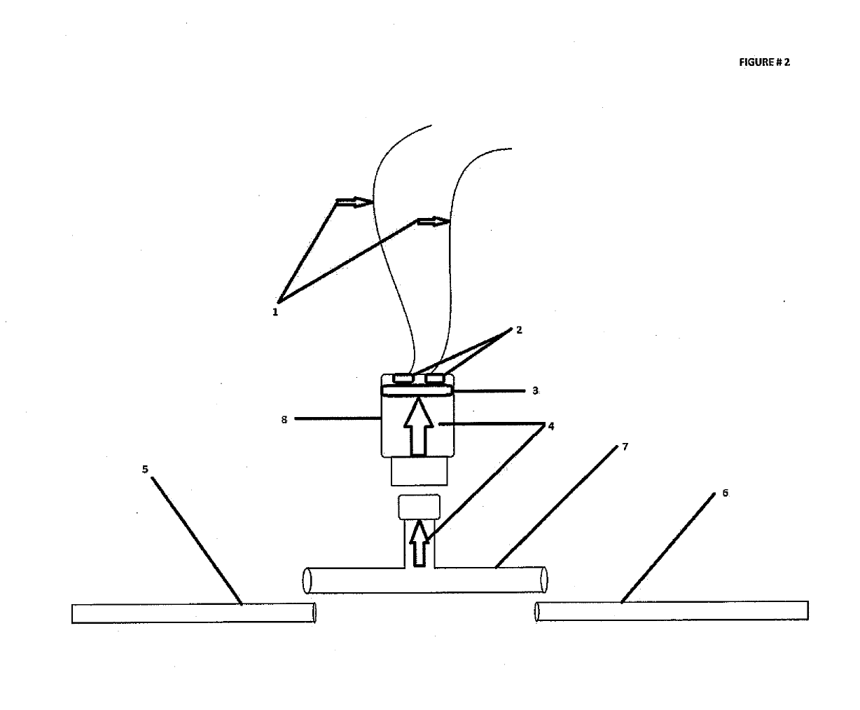

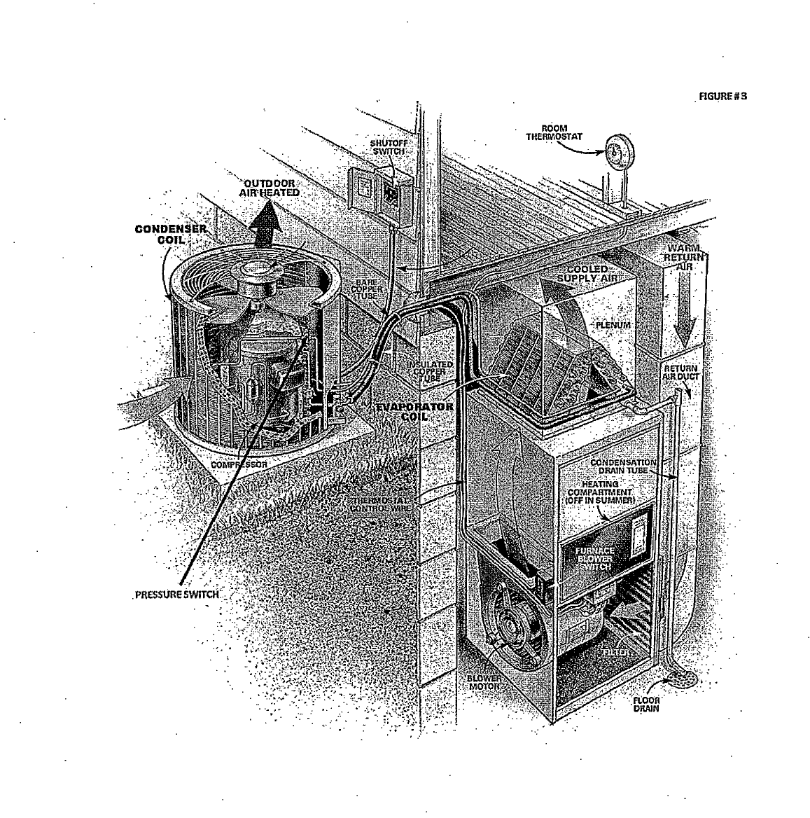

A switch without air pressure is “open” in the off position and will close when the Actuator (FIG. 2-3) inside the switch connects the two contacts (FIG. 2-2). The actuator will close once the gas pressure (FIG. 2-4) reaches 80 psi or higher.

The switch of a normal, functional air conditioning system is usually in the “on” position because of the built air pressure. The pressure built by the Freon gas of an air conditioning system usually oscillates between approximately 120 pounds per square inch (psi), when the unit if turned off to about 225 psi when the unit is running. The switch maintains in the on position between the two levels to allow the unit to start at any moment.

In the event that the Freon gas pressure in the compressor drops below 80 psi, due to a gas leak, the actuator will open and disconnect the two contacts inside the switch and consequently turn off the compressor. The compressor shuts off in order to prevent the compressor from running without a charge or oil. Upon a gas leak, the system also leaks oil. The switch has a trigger to open to the “off” position between 25 psi and 80 psi.

Constant high pressure in the compressor keeps the switch in the “on” position and closed at all times. Additionally, while the switch is wired to the electrical alarm system the circuit will always be closed and the compressor, safe. In the event of a cut to a gas line on the outside unit or compressor, by an unauthorized person, the gas pressure will drop and eventually open the switch to the “off” position. At this point, the alarm circuit will be interrupted and the burglar alarm will be activated. There is no need for the system to be completely empty for the switch to activate the alarm because the valve will open at approximately 25 psi and trigger the notice giving the unauthorized person less time to remove the unit and steal the compressor for scrap metal.

The following illustrates the installation of the pressure switch. The following steps 1 through 4 should be performed by an Air Conditioner Technician and the wiring (step 5) should be installed by an Alarm System Installer. 1—Remove all gas Freon from the air conditioner system. 2—Cut the high pressure line close to the air handler unit, or anywhere inside the premises. 3—Weld the access valve to both ends of the cut line, and screw the high pressure switch to the access valve. (FIG. 2-7) 4—Vacuum the system, and recharge it at proper Freon gas pressures. 5—Wire the pressure switch to the alarm system. (FIG. 1-7)

In case of an attempted theft and someone cuts the copper lines to remove the unit the pressure inside the system will decrease very quickly and the actuator within the pressure switch will open and the alarm will be activated. Because the switch would be installed in the interior of the building it would not be possible for a thief or vandal to jump the switch wires and “trick” the alarm.

The alarm would also be triggered in the case of a line puncturing. If someone punctures the line to inhale Freon the alarm would be set off as the pressure would decrease.

If a residential or commercial site has more than one system, a pressure switch would be installed to each air handler and connected electrically in series to the alarm system so that the alarm system will be triggered from the first cut or puncture of a copper line of any of the units in the series.

What is claimed is:

1. A high pressure switch installed to the high pressure liquid copper lines of an air conditioning unit can trigger an alarm system.

2. A pressure switch of claim 1 is an assembled product available in hardware stores.

3. The copper line of claim 1 is an existing part of a complete air conditioning system.

4. The alarm system in claim 1 has electrical wires that trigger the alarm to be triggered.
